(19) United States
(12) Patent Application Publication
(10) Pub. No.: US 2014/0060034 A1
(43) Pub. Date: Mar. 6, 2014

(54) Electro-Hydraulic Control Design for Pump Discharge Pressure Control

(71) Applicant: Hongliu Du, Naperville, IL (US)

(72) Inventor: Hongliu Du, Naperville, IL (US)

(73) Assignee: CAPTERPILLAR, INC., Peoria, IL (US)

(21) Appl. No.: 13/599,794

(22) Filed: Aug. 30, 2012

(51) Int. Cl. F16D 31/02

(52) U.S. Cl. 60/459

(57) ABSTRACT

An electro-hydraulic control system manages speed of a hydraulic fan by using a solenoid to bias a three position pool of a control valve coupled to a hydraulic pump driving the fan. In a first position, the spool releases pressure on a de-stroke actuator of the pump and allows an on-stroke actuator to increase output pressure corresponding to a speed of an engine driving the pump. In a second position, the spool isolates the de-stroke actuator and fixes the pressure output of the pump. In a third position, the spool couples the de-stroke actuator to the pump output and causes a reduction in the pressure output of the pump. The solenoid coupled to the spool sets the output pressure at which the spool is in the second position.

### TECHNICAL FIELD

The present disclosure generally relates to hydraulics, and more particularly relates to hydraulically operated piston pumps.

### BACKGROUND

Hydraulic fluid is used in a variety of machines to produce useful work. In order to provide the hydraulic fluid to drive cylinders or motors, one or more hydraulic pumps are typically provided on a machine and are driven by the engine of the machine. Such pumps can be provided in a number of different forms, with axial piston pumps being one common example. With an axial hydraulic piston pump, a central barrel or block is rotatedly driven by the motor. The barrel includes a plurality of cylinders each of which is adapted to receive a reciprocating piston. At a driven end, each of the pistons is pivotally and slidably engaged with a swashplate angularly positioned relative to the cylinder barrel. At a work end of each cylinder, a valve plate is provided having two or more inlets and outlets. During the inlet phase of operation, hydraulic fluid is drawn in through the inlet of the valve plate, and into the cylinders of the rotating barrel. This drawing in or filling of the cylinders occurs as the barrel rotates, and the pistons of the barrel proximate to the inlet move from a top dead center position to bottom dead center position. The rotation of the barrel and size of the inlets are such that once the piston reaches its bottom dead center position, the cylinders rotate out of communication with the inlet of the valve plate. Further rotation of the barrel causes the cylinders, now completely filled with hydraulic fluid, to create fluid flow as the pistons move from the bottom dead center position to the top dead center position. During travel from the bottom dead center to the top dead center position, the cylinders are placed into communication with the outlet of the valve plate such that the hydraulic fluid can be delivered from the pump to provide for useful work such as the aforementioned driving of implements, work arms, motors, etc.

Many applications require hydraulic pump pressure control. For example, a hydraulic fan drive system may require variable speed up to a maximum speed, beyond which no further speed increase is either needed or desirable. Ideally, the maximum speed should be settable so that it can be adjusted based on environmental or other conditions.

In applications using hydraulic fan drive speed control, there are two main architectures, a first architecture, a pump pressure control using a load sensing pump with an electro-hydro-mechanical pressure control circuit for generating the load sensing signal and, a second architecture, a displacement controlled pump. In the former architecture, represented by U.S. Patent Application 2004/0261407 to the same inventor as the current disclosure, the margin pressure across the control load sensing control valve will regulate the pump discharge pressure around the load sensing pressure plus margin pressure. In addition to the outer electronic control loop, this control design involves two hydro-mechanical loops, a pressure control loop for load sensing pressure and a pressure control loop for pump discharge pressure. The three control loops can result in some system instability. The electro-hydro-mechanical pressure control circuit can increase the cost and reduce the control system reliability. Further, there is no particular failure mode such that a failure in the control electronics may leave the system in an unknown state.

In the latter system, that uses a displacement controlled pump, the fan speed is directly controlled by the pump flow regardless of the pump discharge pressure. Due to the insensitivity to the fan drive torque (the pump discharge pressure), the displacement controlled pump can put a high load on the engine unnecessarily. Also, because of the large inertia of the fan drive system, the displacement controlled pump can be exposed to low pump discharge pressures that could result in damage to the pump and/or the other components in the related hydraulic system.

### SUMMARY OF THE DISCLOSURE

In one example of the present invention, a hydraulic fan system is provided. The system may include a hydraulic pump configured for variable displacement operation and may include a swashplate that controls a displacement of the hydraulic pump, a discharge signal passage of the pump, an on-stroke actuator coupled to the swashplate that, when advanced, increases an angle of the swashplate to increase a pressure at the discharge signal passage. The on-stroke actuator may also be coupled to the discharge signal passage. The system may also include a de-stroke actuator coupled to the swashplate that, when advanced, decreases an angle of the swashplate to decrease the pressure at the discharge signal passage and a control valve coupled to the on-stroke actuator, the de-stroke actuator of the hydraulic pump, and a tank. The control valve may include a spool responsive to pressure changes at the discharge signal passage and is operable: i) in a first position, to connect the de-stroke actuator to the tank, ii) in a second position, to isolate the de-stroke actuator from both the discharge signal passage and the tank, and iii) in a third position, to connect the de-stroke actuator to the discharge signal passage. The spool may be adapted to respond to increases in pressure in the discharge signal passage by moving consecutively from the first position to the second position to the third position. The control valve may also include a spring that biases the spool toward the first position and a solenoid disposed opposite the spring that provides a settable force that biases the spool toward the third position. Lastly, the system may include a hydraulic motor driving a fan blade, the hydraulic motor coupled to the hydraulic pump and having a speed corresponding to a pressure at the discharge signal passage of the hydraulic pump.

In another embodiment, a pressure control system for use with a variable displacement hydraulic pump may have a swashplate with a swashplate angle controlled by opposing stroke actuators, and may include a control valve hydraulically coupled to a de-stroke actuator, a discharge signal passage of the pump, and a tank, where the discharge signal passage also connected to an on-stroke actuator, a spool of the control valve controllably operable: i) in a first position, to connect the de-stroke actuator to the tank, ii) in a second position, to isolate the de-stroke actuator from both the discharge signal passage and the tank, and iii) in a third position, to connect the de-stroke actuator to the discharge signal passage, the spool adapted to respond to increases in pressure in the discharge signal passage by moving consecutively from the first position to the second position to the third position. The pressure control system may also include a spring that biases the spool toward the first position, and a solenoid disposed opposite the spring that provides a force that biases the spool toward the third position.

In yet another embodiment, a method of operating a hydraulic fan may include, in a first operating mode, providing variable cooling via a hydraulic fan operated at a rate in a direct proportion to a speed of an engine up to a threshold speed of the engine and in a second operating mode, providing constant cooling via the hydraulic fan operated at a fixed rate for any engine speed above the threshold speed of the engine. The method may also include adjusting a solenoid force applied to a hydraulic control valve to set the threshold speed of the engine.

### BRIEF DESCRIPTION OF THE DRAWINGS

FIG. 1 is a schematic of a hydraulic fan drive system.

FIG. 2 is a graph of engine speed vs. hydraulic fan speed for an exemplary embodiment.

FIG. 3 is a diagram of a pressure control system in a first state.

FIG. 4 is a diagram of a pressure control system in a second state.

FIG. 5 is a diagram of a pressure control system in a third state.

FIG. 6 is a flow chart of an exemplary method of operating a pressure control system.

FIG. 7 is a two pump embodiment of a hydraulic fan drive using the pressure control system of FIG. 3.

### DETAILED DESCRIPTION

Generally, a hydraulic fan system uses a hydraulic motor to drive an associated fan. In this environment, hydraulic fan control may be modeled as a function of motor torque and fan torque in view of a discharge pressure of a drive pump. The torque losses on a fan mainly come from friction torque loss and its windage torque loss, where friction torque includes Coulomb friction torque and viscous friction torque. The friction torque can be expressed as:

T_{f}=c_{cf}Pₚ+c_{vd}ω_{F} (1)

where c_{cf} is the constant of Coulomb friction and c_{vd} is the viscous damping coefficient, ω_{F} is the fan speed, and Pₚ is the pump discharge pressure. It should be noted that the friction torque is related to the pump discharge pressure and the fan speed. The windage torque will be in the form of:

T_{w}=c_{wd}ω_{F}² (2)

where c_{wd} is a constant determined by the structure and the geometric parameters of the fan. The drive torque for the fan comes from the hydraulic motor and it can be calculated by:

Tₘ=PₚDₘη_{t,m} (3)

where η_{t,m} is the torque efficiency of the motor. Let J_{F} denote the momentum of the inertia for the fan and the motor, so that the dynamic equation for the fan, using Newton's law, is:

PₚDₘη_{t,m}−c_{cf}Pₚ−c_{vd}ω_{F}−c_{wd}ω_{F}²=J_{F}\dot{ω}ₚ, (4)

Rearranging Eq. (4):

J_{F}\dot{ω}_{F}+c_{vd}ω_{F}+c_{wd}ω_{F}²=(Dₘη_{t,m}−c_{cf})Pₚ (5)

For steady state, \dot{ω}ₚ=0, the torque balance is:

c_{vd}ω_{F}+c_{wd}ω_{F}²=(Dₘη_{t,m}−c_{cf})Pₚ (6)

Eq. (6) indicates that the fan speed can be controlled solely by the pump discharge pressure Pₚ. Therefore, the control of fan speed can be reduced simply to that of controlling pump discharge pressure.

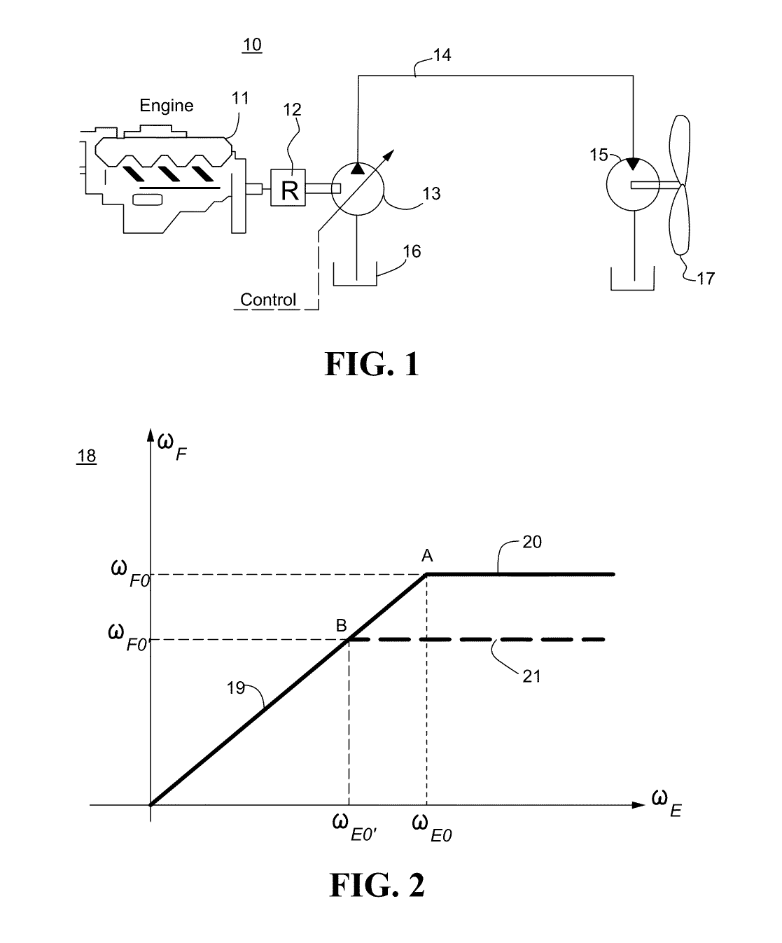

FIG. 1 shows a schematic of a hydraulic fan drive system 10 in accordance with the current disclosure. An engine 11 operates with an engine speed denoted by ω_{E}. The variable displacement pump 13 is operated at the speed of Rω_{E}, where R is the transmission ratio between the pump and the engine. The displacement of the pump, Dₚ, is regulated by an electro-hydraulic (EH) pump discharge pressure control system, discussed further below. A fixed displacement hydraulic motor 15 with the displacement denoted by Dₘ, is connected to the pump via a hydraulic line 14, to form a hydraulic circuit with a reservoir or tank 16. The motor 15 drives a fan 17. This fan drive system 10 is designed to provide adequate cooling with the power consumption capped at a given level set by a higher level power management system (shown as ‘contral’).

FIG. 2 illustrates one embodiment of an ideal mapping 18 from engine speed to fan speed. The mapping contains two regions. The first region 19 illustrates a proportional relationship between engine speed and fan speed. This linear relationship results in an increase in cooling power as the engine speed goes up. However, beyond a certain speed, for both mechanical and aerodynamic reasons, it may be desirable to limit the fan power from increasing when the cooling capability reaches a certain level. Thus, the second region 20 of the engine speed to fan speed mapping illustrates a fixed fan speed independent of engine speed, which in practice gives an essentially constant fan speed, ω_{F0}, after the engine speed passes ω_{E0}. The specific value of the knee points (point A or B corresponding to regions 20 and 21 in the figure) is controlled by an upper level controller (not depicted). That is to say that, in FIG. 1, the fan speed maximum speed may be regulated according to the external control signal. Because, as shown above, when the displacement of the motor 15 is fixed, the fan speed is a function of hydraulic pump output pressure, which in turn, in the first region 19, is related to engine speed.

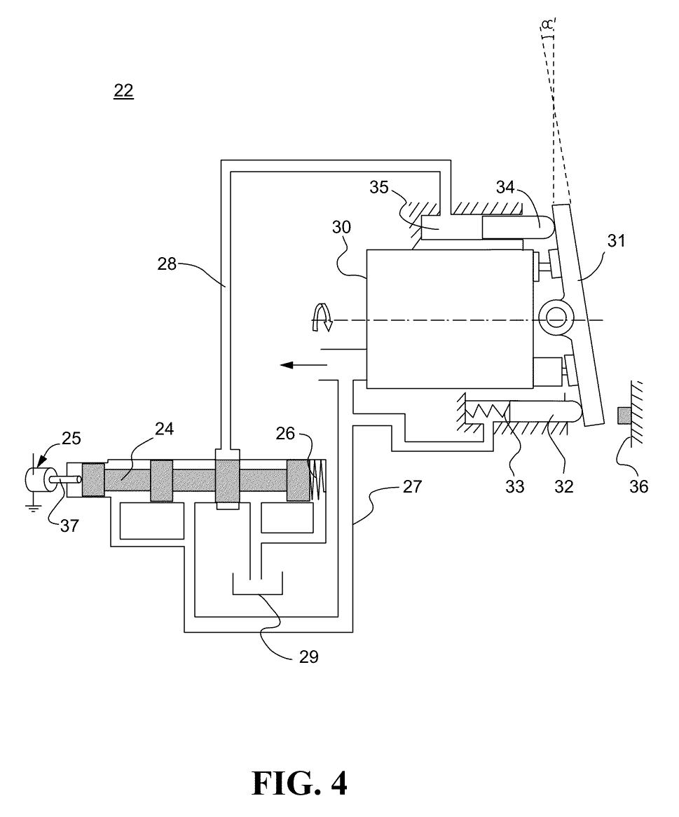

Eq. (5), above, reveals that the pump discharge pressure is dynamically related to the fan speed and physically the two variables will reach the equilibrium expressed by Eq. (6). In other word, equations (5) and (6) show that control of the fan speed can be implemented by controlling the pump discharge pressure. Based on this, FIG. 4 illustrates an exemplary control system configuration.

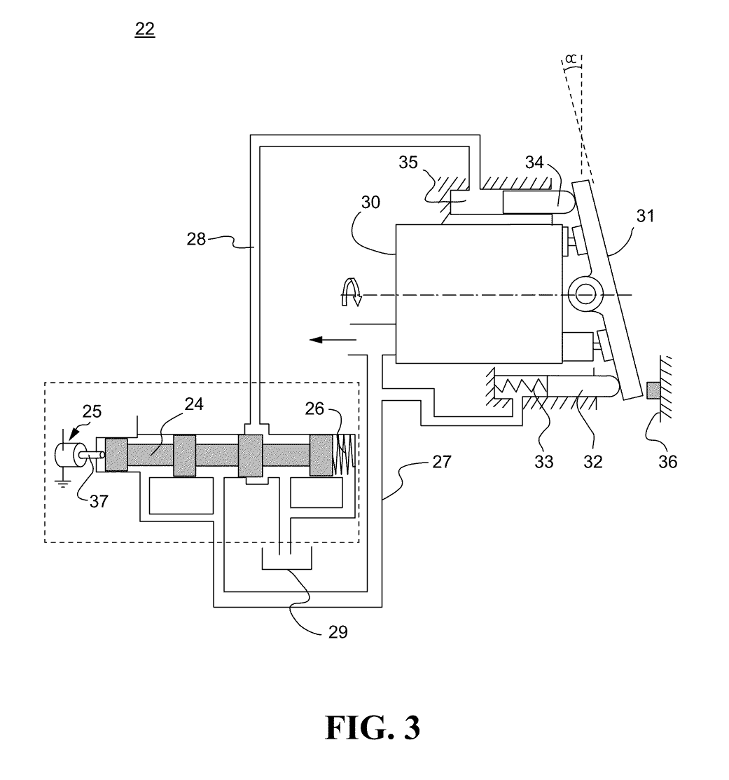

FIGS. 3-5 illustrate a pressure control system 22 that may be an embodiment of the variable displacement pump 13 of FIG. 1 implementing electro-hydraulic control of pressure.

Referring to FIG. 3, the pressure control system 22 may include a control valve 23 that uses a 3-way spool 24 for metering flow into or out of the pump control actuator chamber 35 to change the control pressure Pc. The spool 24 can have a first land 50 and a larger second land 52. Pump discharge pressure feedback is used as part of the actuation of the spool 24 via a spool land differential area ΔAₛᵢ between the first and second lands. The pressure control system also may have a solenoid 25 that changes the pump discharge pressure at system equilibrium (or the maximum fan speed) and a spring 26 to provide a balance force. The valve spool 24 is balanced by, at steady state,

Fₛₚₚᵢ+K_{sprg}xᵥ=Fₛ+ΔAₛᵢPₚ (7)

where Fₛₚₚᵢ is the pre-load force on the spring, K_{sprg} is the spring rate of the balance spring, Fₛ is the solenoid force, xᵥ is the spool metering land position, and ΔAₛᵢ is the area difference between the metering land 50 and the pressure feedback land 52. The origin (or first position) of the spool is when the spool touches the very left end (the solenoid side), as shown in FIG. 3. Let x_{v,0} be the traveling distance of the spool from its original position to the valve null position (shown in FIG. 4), F_{s,max} be the maximum solenoid force for leveling out the fan speed, and P_{p,min} be the minimum pump discharge pressure, then, the spring preload, spring rate, and the pressure feedback differential area should satisfy:

Fₛₚₚᵢ+k_{sprg}+x_{v,0}=F_{s,max}+ΔAₛᵢP_{p,min} (8)

On the other hand, with zero as the minimum solenoid force for the constant fan speed, or F_{s,min}=0, we have

Fₛₚₚᵢ+k_{sprg}x_{v,0}=ΔAₛᵢP_{p,min} (9)

By Eqs. (8) and (9), the differential area can be calculated by

ΔAₛᵢ=F_{s,max} P_{p,max}−P_{p,min} (10)

Given the spool differential area, the control valve can be designed to meet the requirements for given application with the appropriate areas for the metering land 50 and the pressure feedback land 52.

In an exemplary embodiment, the pressure control system 22 may also include a pump discharge line or passage 27, a control line 28, a hydraulic pump 30 including a variable pitch swashplate 31, an on-stroke actuator 32, an on-stroke bias spring 33, a de-stroke actuator 34, the pump control actuator chamber 35, and an on-stroke hard stop 36 that limits the maximum angle of the swashplate and therefore the maximum pressure output of the pump 30. The pressure control system 22 may also include pressure equalizing passages 38 and 39 that surround lands 52 and 56, respectively. A cutoff land 54 may divert pressure to the pump control actuator chamber 35, as described further below. Other embodiments of the pressure control system 22 may be contemplated beyond the illustrated exemplary embodiment, such as different configurations of spool 24, actuators 32, 34, etc., without affecting the functions performed to achieve pump pressure control.

In operation, the pressure control system 22 may begin operation as illustrated in FIG. 3. The on-stroke actuator 32, using the bias spring 33, moves the swashplate 31 to its maximum position, limited by the on-stroke hard stop 36. The spool 24 is in an origin position, so that the pump control actuator chamber 35 is coupled to the tank 29. In this position, the swashplate 31 is set to a maximum angle and the pump develops maximum pressure at the pump discharge signal passage 27 for a given engine speed. As a result, the output pressure of the pump is in the linear region and a hydraulic fan coupled to the pump would operate in the linear region 19 illustrated in FIG. 2. As the engine speed increases, pump output pressure increases and the differential area of lands 50 and 52 in concert with the force of the solenoid 25 causes the spool 24 to move to the right, away from the solenoid.

FIG. 4 illustrates a null, or second, position of the spool 24 resulting from this movement. In this position, the pump control actuator chamber 35 is isolated from both the discharge signal passage 27 and the tank 29 so that the de-stroke actuator 34 is fixed in position. This position prevents further movement of the swashplate 31. Therefore, the pressure of the pump 30 is fixed for a given engine speed.

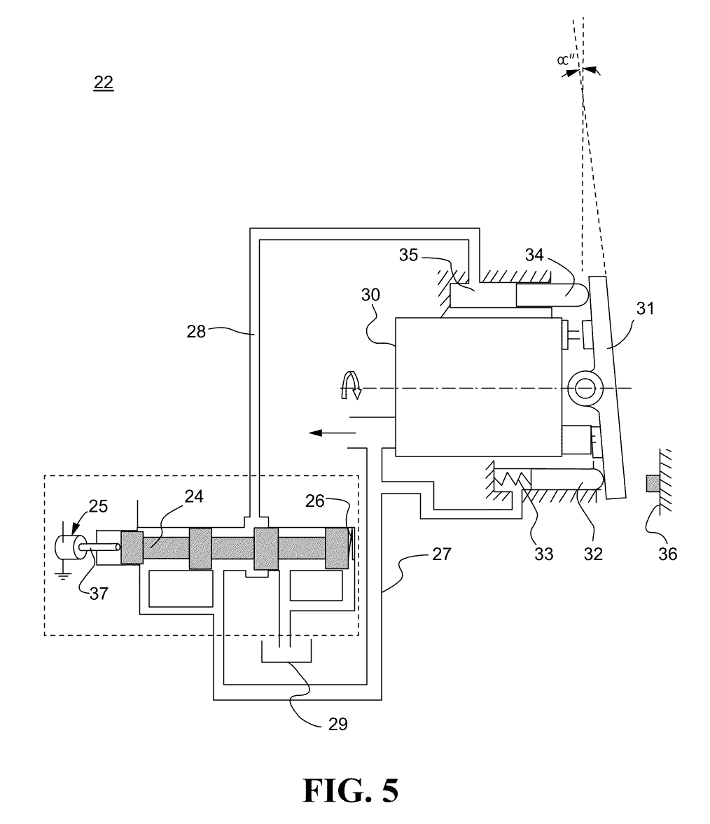

Referring to FIG. 5, the spool 24 is shown in a third position resulting from an increase in pressure in the discharge signal passage 27 that causes the spool to move further away from the origin position and past the null position illustrated in FIG. 4. The increase in pressure may be primarily the result of an increase in engine speed although other influences, such as leakage in the pump control actuator chamber 35 allowing a change in swashplate angle may also occur. With the spool 24 in this third position, the control valve 23 connects the discharge signal passage 27 to the control line 28 and increases the pressure in the pump control actuator chamber 35. As a result, the de-stroke actuator 34 reduces the angle of the swashplate 31 causing a reduction in pump output pressure. Eventually, this negative feedback will reduce the pressure in the discharge signal passage 27 and return the spool 31 to the null position illustrated in FIG. 4.

Correspondingly, when the engine speed is reduced, the output pressure drops and the spool 24 will move to the first position illustrated in FIG. 3 and the pump pressure will increase until pump pressure reaches a maximum output determined by the hard stop 36 or the spool is driven back to the null position of FIG. 4.

While this negative feedback system is useful as described, an additional level of flexibility is available via the further ability to set the knee (e.g., point A of FIG. 2) between the linear and constant speed regions of operation by the adjusting the force applied at the solenoid 25. As is known, an increase in electrical current through a solenoid coil increases the pressure output of the solenoid shaft 37. By changing the solenoid pressure, the pump pressure required to move the spool 24 to the null position may be varied.

Therefore, the threshold engine speed at which the pressure control system 22 changes from a first operating mode of variable pump pressure and fan speed to a second operating mode with constant pump pressure and fan speed independent of engine speed, may be controlled electrically by adjusting the current through the solenoid. This allows a variety of factors affecting operation of the overall machine to influence, in this embodiment, fan speed and cooling capacity. Fan speed and, ultimately, cooling capacity is therefore settable based on observed or measured factors. For example, an extremely cold environment may have a reduced cooling requirement so that engine power may be diverted from the fan and applied to other areas of the machine. Or, in another example, extreme loads on the machine may increase the cooling requirement, requiring a higher maximum fan speed.

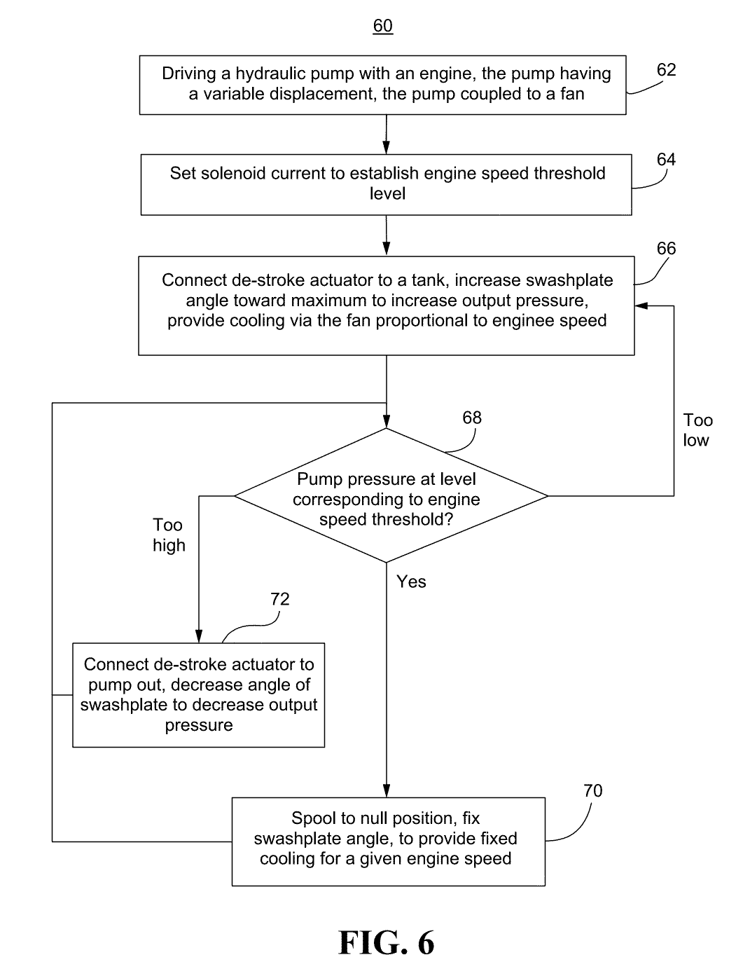

FIG. 6 is a flow chart of a method 60 of operating a hydraulic fan with a pressure control system. At a block 62, an engine 11 drives a hydraulic pump 30, the hydraulic pump having a variable displacement output settable by an angle of a swashplate 31. The hydraulic pump 30 drives a hydraulic fan 17 with a speed responsive to an output pressure of the variable displacement hydraulic pump 30, the hydraulic pump speed is a direct function of a speed of the engine 11.

At a block 64, a solenoid current is established that sets a force to bias a spool of a pressure control valve. At a block 66, in a first operating mode, the hydraulic fan 17 is operated to provide variable cooling at a rate in a direct proportion to a speed of the engine 11 up to a threshold speed of the engine 11. In the first operating mode, a spool 24 of the control valve 23 is set to a first position that connects a de-stroke actuator 34 of the hydraulic pump to a low pressure tank 29. Further, the spool 24 at the first position permits pressure applied to an on-stroke actuator to increase the angle of a swashplate causing an increase in output pressure of the hydraulic pump. Therefore, a change in engine speed affects speed of the pump 30 and causes a proportional change in the output pressure of the pump 30. Because the hydraulic fan speed is a direct function of pump pressure, the cooling provided by the fan is proportional to the engine speed, when operating in the first mode.

Adjusting the solenoid force applied to the control valve to zero sets the threshold speed of the engine to a maximum engine speed. That is, setting the solenoid force to zero, or a failure of the solenoid (25) or its drive circuit, will remove any limit on maximum pressure and allow a failsafe mode of maximum pressure and in an exemplary embodiment, maximum fan speed.

At a block 68, pressure change at the pump 30 is measured in accordance with equation (7) above. When the output pressure of the pump is at the set level, the ‘Yes’ branch may be taken from the block 68 to a block 70. At the block 70, in a second operating mode, a spool 24 of the control valve 23 is set to a second position that isolates a de-stroke actuator 34 of the hydraulic pump 30 and fixes an angle of a swashplate to provide a constant pressure output of the hydraulic pump 30. Constant cooling is provided via the hydraulic fan 17 operated at a fixed rate for a given engine speed above the threshold speed setting.

Returning to the block 68, if a pressure increase at the output of the pump is detected, for example, if the engine speed increases, the ‘Too high’ branch from block 68 may be taken to block 72. While still operating in the second operating mode, the spool 24 of the control valve 23 may be set to a third position that connects the de-stroke actuator 34 of the hydraulic pump 30 to a discharge signal passage 27, or output, of the hydraulic pump causing the de-stroke actuator 34 to decrease an angle of a swashplate 31 to reduce an output pressure of the hydraulic pump 30. The cooling provided by the fan will remain virtually constant as the spool 24 is returned to the null position (see FIG. 4) by the negative pressure feedback of the de-stroke actuator 34.

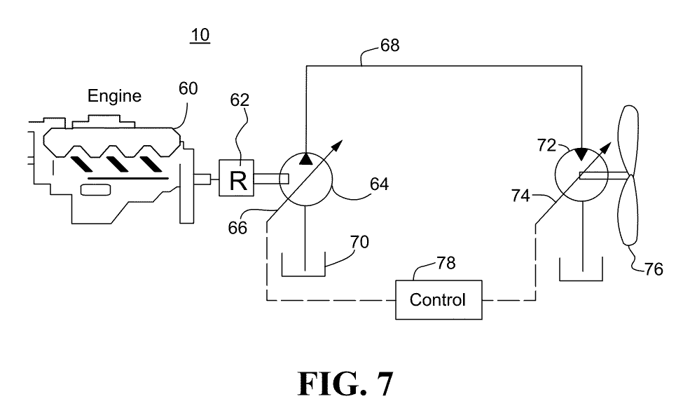

FIG. 7 illustrates a two-pump configuration, similar to the design of FIG. 1. FIG. 7 has an engine 60 driving a variable displacement pump 64 via a transmission 62. The speed of the variable displacement pump 64 is a function of the engine speed and a ratio ‘R’ of the transmission 62. The pressure of the pump 64 may be controlled by controlling a swashplate as described above and as indicated by variable control 66. A hydraulic line 68 may convey hydraulic fluid from a reservoir 70 to a variable displacement motor 72 as indicated by variable control 74 that may be embodied as an adjustable swashplate. The speed of the fan 76 is then a function of both the pressure delivered via hydraulic line 68 and the output power conversion of the variable displacement motor 72. A controller 78 may be used to selectively adjust both the pump 64 and the motor 72 to achieve the desired cooling effect. In such an application, the hydraulic line 68 may feed an additional fan (not depicted) or other hydraulically-driven apparatus. This configuration allows a minimum required pressure to be delivered to the additional apparatus and still allow the fan 76 to achieve its desired level of cooling. In situations where all power is diverted to another load, the pump 64 may shut down both the fan 76 and the additional apparatus. In comparison to the prior art systems, the current design offers a stable, low cost, high reliability solution. Even in the more complex two pump configuration described above in FIG. 7, by using the disclosed system and method, the pump pressure may be controlled by one swashplate and the pump displacement may be controlled by the other swashplate. Since the control variables are decoupled, the pressure control and displacement control can be used directly without jeopardizing system stability.

The configuration described may also be used in applications requiring failsafe operation at maximum output pressure or maximum speed. As can be seen, if the power to the solenoid is interrupted, a properly sized differential land area between lands 50 and 52 will drive the spool 24 to the first position and allow the pump 30 to operate at full displacement for any engine speed.

### INDUSTRIAL APPLICABILITY

In general, the present disclosure describes a hydraulic pump pressure control system that uses an electro-hydraulic control to variably set a maximum pump output pressure. A variety of hydraulically operated equipment may benefit from the ability to use the hydraulic negative feedback and settable maximum pressure provided by this system and method. In the exemplary embodiment, the fan control system provides the ability to tailor the cooling provided to match the system needs, based on factors including ambient temperature, heat generated, fan noise, fan power, etc. This capability is particularly applicable to heavy machinery, such as earthmoving equipment, tractors, loaders, etc.

The hydraulic pump pressure control system eliminates the multiple pressure sensing control loops of the prior art system resulting in a more stable system.

In other embodiments, any hydraulically operated mechanism requiring a settable constant maximum pressure may benefit from the above-described system and method, especially when pump speed is subject to wide variations.

In still other embodiments, any system requiring a failsafe mode of maximum pressure or maximum speed may use this system and method. Should there be a failure in the solenoid or the electrical system operating the solenoid, the pressure control system will operate in the first mode with the swashplate kept at the maximum angle to provide a maximum available pressure at the pump output and correspondingly, maximum speed to an implement such as a fan.

What is claimed is:

1. A method of operating a hydraulic fan comprising:
in a first operating mode, providing variable cooling via a hydraulic fan operated at a rate in a direct proportion to a speed of an engine up to a threshold speed of the engine;
in a second operating mode, providing constant cooling via the hydraulic fan operated at a fixed rate for any engine speed above the threshold speed of the engine; and
adjusting a solenoid force applied to a hydraulic control valve coupled to the engine and the hydraulic fan to set the threshold speed of the engine.

2. The method of claim 1, further comprising:
driving a hydraulic pump with the engine, the hydraulic pump having a variable displacement output settable by an angle of a swashplate.

3. The method of claim 1, further comprising:
in the first operating mode, setting a spool of the control valve to a first position that connects a de-stroke actuator of the hydraulic pump to a low pressure tank and permits pressure applied to an on-stroke actuator to increase the angle of a swashplate causing an increase in output pressure of the hydraulic pump.

4. The method of claim 1, further comprising:
in the second operating mode, setting a spool of the control valve to a second position that isolates a de-stroke actuator of the hydraulic pump and fixes an angle of a swashplate to provide a constant pressure output of the hydraulic pump.

5. The method of claim 1, further comprising:
in the second operating mode, setting a spool of the control valve to a third position that connects a de-stroke actuator of the hydraulic pump to an output of the hydraulic pump causing the de-stroke actuator to decrease an angle of a swashplate to reduce an output pressure of the hydraulic pump.

6. The method of claim 1, wherein adjusting the solenoid force applied to the hydraulic control valve comprises adjusting the solenoid force applied to the control valve to zero sets the threshold speed of the engine to a maximum engine speed.

7. A hydraulic fan system comprising:
a hydraulic pump configured for variable displacement operation including:
a swashplate that controls a displacement of the hydraulic pump;
a discharge signal passage;
an on-stroke actuator coupled to the swashplate that, when advanced, increases an angle of the swashplate to increase a pressure at the discharge signal passage, the on-stroke actuator further coupled to the discharge signal passage;
a de-stroke actuator coupled to the swashplate that, when advanced, decreases an angle of the swashplate to decrease the pressure at the discharge signal passage; and
a control valve coupled to the on-stroke actuator, the de-stroke actuator of the hydraulic pump, and a tank, the control valve including:
a spool responsive to pressure changes at the discharge signal passage and operable: i) in a first position, to connect the de-stroke actuator to the tank, ii) in a second position, to isolate the de-stroke actuator from both the discharge signal passage and the tank, and iii) in a third position, to connect the de-stroke actuator to the discharge signal passage, the spool adapted to respond to increases in pressure in the discharge signal passage by moving consecutively from the first position to the second position to the third position;
a spring that biases the spool toward the first position; and
a solenoid disposed opposite the spring that provides a settable force that biases the spool toward the third position; and
a hydraulic motor driving a fan blade, the hydraulic motor coupled to the hydraulic pump and having a speed corresponding to a pressure at the discharge signal passage of the hydraulic pump.

8. The hydraulic fan system of claim 7, wherein the on-stroke actuator includes a bias spring to place the hydraulic pump in a maximum displacement state absent pressure at the discharge signal passage.

9. The hydraulic fan system of claim 7, wherein a land area of the de-stroke actuator is larger than a land area of the on-stroke actuator such that exposure of both actuators to pressure from the discharge signal passage causes the swashplate to de-stroke the hydraulic pump.

10. The hydraulic fan system of claim 9, wherein the land area of the de-stroke actuator is sufficiently larger than the land area of the on-stroke actuator to overcome the force of the bias spring and the on-stroke actuator when both actuators are exposed to pressure from the discharge signal passage.

11. The hydraulic fan system of claim 7, wherein the spool has a spool lands differential area between a first spool land and a second spool land that results in spool movement in a direction from the first position toward the third position responsive to increases in pressure in the discharge signal passage.

12. The hydraulic fan system of claim 7, further comprising a hard stop that limits a maximum on-stroke angle of the swashplate.

13. The hydraulic fan system of claim 7, wherein the settable force of the solenoid is set to a force corresponding to a maximum desired hydraulic pump output pressure.

14. A pressure control system for use with a variable displacement hydraulic pump having a swashplate with a swashplate angle controlled by opposing stroke actuators, the pressure control system comprising:
a control valve hydraulically coupled to a de-stroke actuator, a discharge signal passage of the pump, and a tank, the discharge signal passage also connected to an on-stroke actuator;
a spool of the control valve controllably operable: i) in a first position, to connect the de-stroke actuator to the tank, ii) in a second position, to isolate the de-stroke actuator from both the discharge signal passage and the tank, and iii) in a third position, to connect the de-stroke actuator to the discharge signal passage, the spool adapted to respond to increases in pressure in the discharge signal passage by moving consecutively from the first position to the second position to the third position;
a spring that biases the spool toward the first position; and
a solenoid disposed opposite the spring that provides a force that biases the spool toward the third position.

15. The pressure control system of claim 14, wherein the force of the solenoid is controllable.

16. The pressure control system of claim 15, wherein the force of the solenoid corresponds to a maximum desired hydraulic pump output pressure.

17. The pressure control system of claim 14, wherein the spool has a spool lands differential area between a first spool land and a second spool land that results in spool movement in a direction from the first position toward the third position responsive to increases in pressure in the discharge signal passage.

18. The pressure control system of claim 14, wherein a decrease in pressure in the discharge signal passage allows the spring to move the spool toward the first position.

19. The pressure control system of claim 18, wherein a pressure in the discharge signal passage that causes the spring to move the spool toward the first position is determined by the settable force supplied by the solenoid.

20. The pressure control system of claim 14, wherein in a failure of the solenoid causing a loss of force that biases the spool toward the third position allows the spool to travel to the first position and causes the pump to output a maximum pressure.
